(19) United States
(12) Patent Application Publication
(10) Pub. No.: US 2013/0094794 A1
(43) Pub. Date: Apr. 18, 2013

(54) Dirt filter for moveable parts

(71) Applicant: Wolfhart Willimczik, Bradenton, FL (US)

(72) Inventor: Wolfhart Willimczik, Bradenton, FL (US)

(21) Appl. No.: 13/272,493

(22) Filed: Oct. 13, 2011

(51) Int. Cl. F16C 33/78; B01D 39/00; F16J 15/34

(52) U.S. Cl. 384/477; 277/399; 55/522

(57) ABSTRACT

To protect moveable—mostly sliding parts from dirt porous filter material is placed in a closest way directly on one of the moveable partners; for instance directly in both fronts of a ball bearing running submerged in sea water to repel and absorb dirt particles on the way to the inner rolling parts. This will extend the service live under difficult conditions. In case of a mechanical shaft seal a filter ring is placed directly besides the sealing ring sliding together on a seat ring. Such filter ring protects the sensitive sliding surfaces much more completely than dirt rings in use, because they not only repel dirt, but absorb single dirt particles in its pores even in the sliding surface.

### FIELD OF THE INVENTION

This invention combines a common dirt filter and a dirt guard directly on a movable wear part to prevent damage of sensible surfaces by dirt. This invention brings the dirt filter directly to the movable part. It is preferable made for difficult oil-less applications.

### BACKGROUND ART

Sliding parts like seals, bearings etc are everywhere in our machinery, engines, pumps, compressors and also in the newest sea water hydraulic motors like Wolfhart Motors and others. Only few grains of sand can damage such parts. To prevent this expensive filter systems outside the machinery are in use. In case of the water hydraulic loose rust after the filter can also destroy vital parts of a pump or water hydraulic motor. Not using oil for lubrication creates a big dirt problem, especially at using sea water as hydraulic fluid for under water work, but also for all shaft seals and bearings in use. There are some dirt rings in rubber material in use. They repel only some dirt, but they are unable to absorb dirt to prevent damages by dirt completely.

### SUMMARY OF THIS INVENTION

This invention is in regard of dirt filter designs attached to sliding parts like shaft seals to prevent damage by foreign particles slipping between the sliding parts. The goal of this invention is to lengthen the live span of wear parts—any kind of bearing in any machinery like pumps etc which are not oil-lubricated, but subjected to small amounts of dirt like mechanical shaft seals, slipper valves for the piston forces in water hydraulic motors, ball bearings running submerged in water. Common dirt rings use not porous filter material. Porous material repels and absorbs dirt particles in the pores. Who ever worked with porous plastic know how strong it contracts dirt. It is hardly possible to wipe it off. It remains imbedded in the pores. The gap between two sliding parts is covered with a porous filter material at the closest possible way—except the sliding surface itself. Mostly the filter material moves with one of the sliding partners. This means for a dirt particle it must first though sliding partners, whereby one has a porous surface, before it may enter between the two sensitive sliding surfaces of a mechanical shaft seal. The porous filter material let the fluid through, but repels and absorbs dirt particles like sand, rust etc in its pores. Depending on the application any fine filter material can be used. A certain elasticity is desired in most cases. A porous and soft plastic material work good in water for mechanical shaft seals as a ring around the rotating face inside and outside if there is enough room, but mostly only outside—the side of the fluid in the pump. A second filter ring can be placed on the reverse side of the seat ring around the shaft sliding on the seat ring which is mostly in ceramic. It exerts no high sliding forces that it becomes itself a wear problem even if it is slightly compressed if new installed. It works still even if there is a small gap building up between the stationary shaft seat and the filter ring. The gap is fluctuating, because a loose ring is vibrating and catches a single particle in its pores before it can get though to the sliding sealing face of the mechanical shaft seal.

The entire shaft seal can be build cheaper, because for the sealing face there can be taken low grade carbon which never destroys the ceramic seat. Such balanced seal holds up even against high pressure (1000 PSI and over) as long it is protected against dirt particles. (Harder materials destroy always both itself and the ceramic seat if hard particles like sand are coming in.)

If too much dirt is coming in or after time the porous material will not be able to absorb any more dirt if all pores are full with dirt. In this case some loose accumulated dirt will be wiped off again by a small groove with sharp edges like a secant for the outer circle of the seat ring and tangent for the outer circle of the sealing face. The groove can also go slightly under the sealing face. It wipes off a single dirt particle what reached the seal face. To make the load rotational symmetrically again, 180° further there may be a second groove with the same dimension.

This technology can be used basically for many wear parts subjected to dirt.

### BRIEF DESCRIPTION OF THE DRAWING

FIG. 1 shows a half of a cross section of a shaft seal

### DETAILED DESCRIPTION OF THE PREFERRED EMBODIMENTS

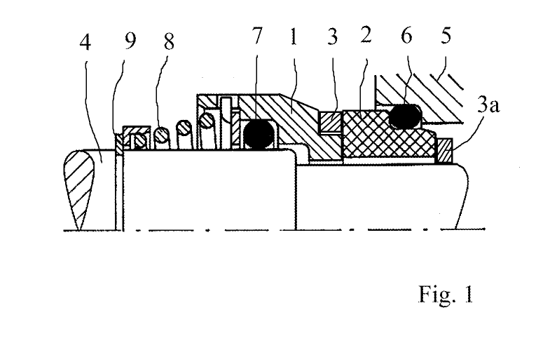

FIG. 1 shows a half of a cross section of an ordinary shaft seal around the shaft 4. The shaft seal is pressure balanced by the step in the shaft and suitable for high pressure clean water. One extraordinary part is a ring 3 around the ring shaped carbon face of the rotating part of the shaft seal called body 1. Both turning together and sliding on a ceramic seat 2 which is placed via the O-ring 6 in the stationary housing 5. The ring 3 consists of a porous plastic material and is not rigidly fixed to the body 1. It could also turn around the body 1, but the friction coefficient of smooth ceramic is smaller—ergo it will mostly turn with the body 1 as long nothing extraordinary happens. The elastic plastic ring 3 is slightly compressed in axial direction with it is able to repel most of foreign particles like rust, sand etc protecting the sensitive sealing face of the seal. That far a normal plastic ring could do this also, but this ring is able to catch and absorb particles, which are already between this ring and the ceramic seat. This particle will not go further to the sealing surfaces and damage them, because it will be embedded in one pore of the ring 3.

The rest is common technology.

The body 1 is sealed to the shaft 4 via the O-ring 7.

A snap ring 9 holds the spring 8 in axial direction to pre-load the seal without any water pressure.

1. A dirt filter on a moveable machine part, consisting preferably of an elastic porous material.

2. A dirt filter on a moveable machine part according to claim 1, preferably ring shaped and attached to one or both sides of a ball bearing.

3. A dirt filter on a moveable machine part according to claim 1, being ring shaped and loosely attached to the rotating face of a mechanical shaft seal sliding together on a stationary seat ring and a possible second filter ring sliding between the backside of the seat and the shaft.

4. A dirt filter ring on a mechanical shaft seal according to claim 3, sliding over at least one small groove in the seat with sharp edges to wipe off accumulated loose dirt.
